(19) United States
(12) Patent Application Publication
(10) Pub. No.: US 2025/0287256 A1
(43) Pub. Date: Sep. 11, 2025

(54) FIFTH GENERATION SYSTEM QUALITY OF SERVICE USING MEDICAL STATES

(71) Applicant: Telefonaktiebolaget LM Ericsson (publ), Stockholm (SE)

(72) Inventors: Stefan DAHLFORT, Los Gatos, CA (US); Andrew WILKINSON, Santa Cruz, CA (US)

(21) Appl. No.: 18/859,742

(22) PCT Filed: Apr. 26, 2022
(86) PCT No.: PCT/IB2022/053869

§ 371 Date: Oct. 24, 2024

(51) Int. Cl. H04W 28/02; H04L 47/2425

(52) U.S. Cl. CPC H04W 28/0215; H04L 47/2433; H04W 28/0268

(57) ABSTRACT

A communication device can determine information associated with a medical state of a patient associated with the communication device. The communication device can further determine a priority of data associated with the patient based on the information. The communication device can further communicate data associated with the patient using the priority.

### INTRODUCTION

The present disclosure is related to wireless communication systems and more particularly to using a medical state of a patient to determine a quality of service level used for data connectivity of medical data associated with the patient.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), and multiple communication devices 110 (also referred to as user equipment (“UE”)).

Cellular technologies, such as 5G, are increasingly used for healthcare. As with all communications systems, a 5G system (“5GS”) may be resource constrained during peak traffic events (e.g., system failure events or natural catastrophes), in which case traffic prioritization is necessary to continue to deliver important traffic. This traffic prioritization can be performed by the 5GS quality of service (“QoS”) functions.

### SUMMARY

In some embodiments, a method of operating a communication device in a communications network that includes a network node is provided. The method includes determining information associated with a medical state of a patient associated with the communication device. The method further includes determining a priority of data associated with the patient based on the information. The method further includes communicating data associated with the patient using the priority.

In other embodiments, a method of operating a network node in a communications network that includes a communication device is provided. The method includes receiving information associated with a medical state of a patient, the patient being associated with the communication device. The method further includes determining a priority of data associated with the patient based on the information. The method further includes prioritizing data associated with the patient based on the priority of the data.

In other embodiments, a communication device, network node, computer program, computer program product, or non-transitory computer-readable medium is provided for performing one of the methods above.

In some embodiments, prioritizing data associated with a patient based on their medical state can reduce the risk of the patient's vital medical data being lost by the wireless network, and thereby going unnoticed by medical staff.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of a 5G system (“5GS”) Quality of Service (“QoS”) architecture;

FIG. 3 is a schematic diagram illustrating an example of 5GS connectivity concepts for QoS;

FIG. 4 is a table illustrating an example of a scoring system for a set of medical measurements;

FIG. 5 is a table illustrating an example of a clinical risk and response associated with a score from the scoring system in FIG. 4;

FIG. 6 is a schematic diagram illustrating an example of a framework for a 5GS QoS using medical states in accordance with some embodiments;

FIG. 7 is a flow chart illustrating an example of operations performed by a remote UE in accordance with some embodiments;

FIG. 8 is a flow chart illustrating an example of operations performed by a relay UE in accordance with some embodiments;

FIG. 9 is a block diagram of a communication system in accordance with some embodiments;

FIG. 10 is a block diagram of a user equipment in accordance with some embodiments

FIG. 11 is a block diagram of a network node in accordance with some embodiments;

FIG. 12 is a block diagram of a host computer communicating with a user equipment in accordance with some embodiments;

FIG. 13 is a block diagram of a virtualization environment in accordance with some embodiments; and

FIG. 14 is a block diagram of a host computer communicating via a base station with a user equipment over a partially wireless connection in accordance with some embodiments.

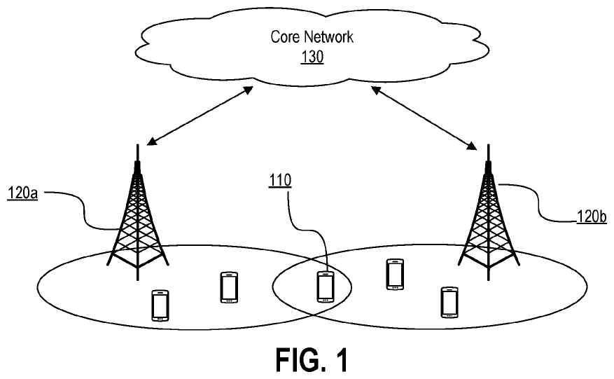

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

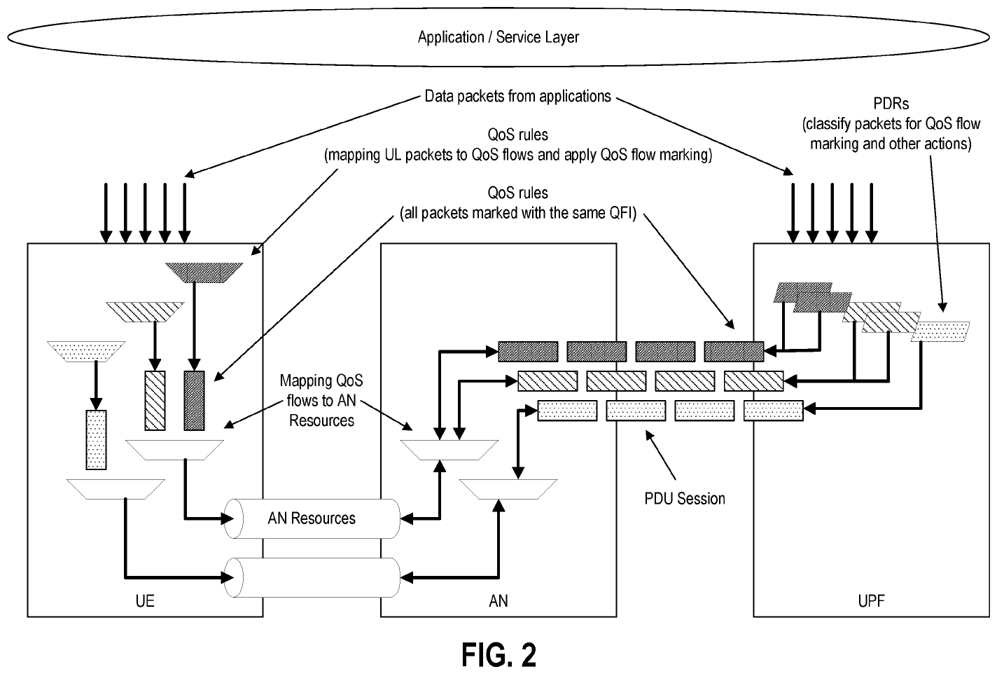

A 5th Generation system (“5GS”) used in a hospital for example may set Quality of Service (“QoS”) levels based on the type of traffic (e.g., patient measurements of vital signs or medical imaging scans), but that can result in unwanted and detrimental effects: one example would be that a relatively healthy person's pulse measurement is prioritized over a critically ill patient's blood pressure measurement. Losing the latter data during a high data peak time period may result in the medical doctors not detecting a patient going into a critical condition, that may be fatal. There are no solutions that consider the patients' medical conditions to define, set, and change (modify) the QoS levels in 5GS. FIG. 2 illustrates an example of a 5GS that offers QoS across the 5GS.

QoS includes requirements on all the aspects of connection impairments, such as service response time, loss of data and service, delays, etc. QoS offers the ability to provide different priority to different applications, users, or data flows, or to guarantee a certain level of performance to a data flow.

In 5G new radio (“NR”), QOS is enforced at the QoS flow level. Packet Detection Rules (“PDRs”) are used by the UPF to classify packets for QoS flow marking using a QoS Flow Identifier (“QFI”). The 5G QoS flows are mapped in the Access Network (“AN”) to Data Radio Bearers (“DRBs”) unlike in 4th Generation (“4G”) where mapping is one to one between Evolved Packet Core (“EPC”) and Radio Bearers. 5G QoS architecture supports the following QoS flow types: Guaranteed Bit Rate (“GBR”) QoS flow; non-GBR QoS flow; and Delay Critical QoS flow. The GBR QoS flow requires a guaranteed flow bit rate. The non-GBR QoS flow does not require guaranteed flow bit rate. The Delay Critical QoS flow is for mission critical guaranteed flow bit rate.

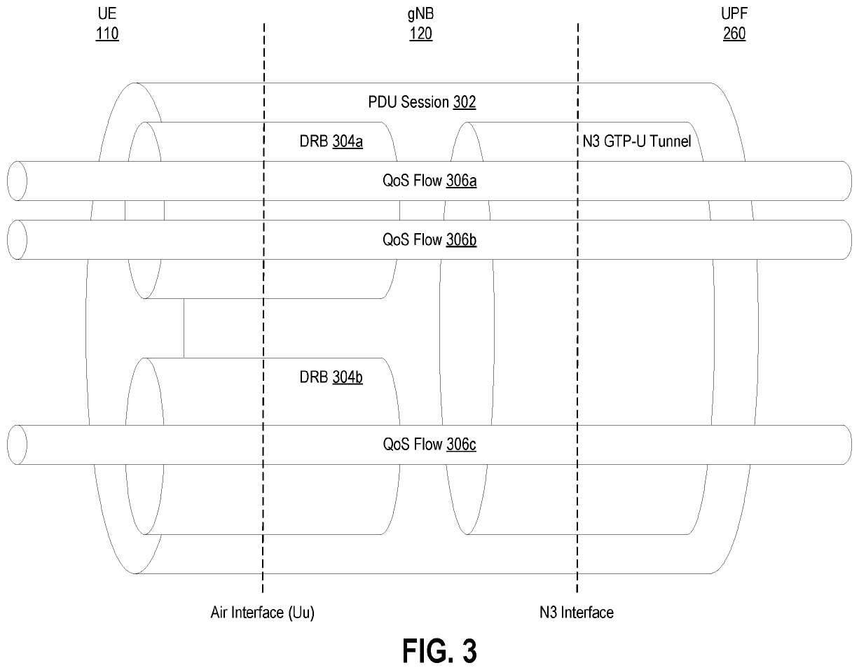

The QoS architecture in 5G, 5G radio access network (“RAN”) is connected to 5G Core as it is depicted in FIG. 3. The 5G Core establishes one or more protocol data unit (“PDU”) sessions 302 for each UE 110. The 5G-RAN establishes at least one DRB 304a together with the PDU Session 302 and additional DRB(s) 304b for QoS flow(s) 306a-c of that PDU session 302 can be subsequently configured for each UE 110. The 5G-RAN maps packets belonging to different PDU sessions 302 to different DRBs 304a-b. The non-access stratum (“NAS”) level packet filters in the UE 110 and in the 5GC associate uplink (“UL”) and downlink (“DL”) packets with QoS flows. The Access Stratum (“AS”) level mapping rules in the UE 110 and in the 5G-RAN associate UL and DL QoS flows with DRBs 304a-b.

The 5G RAN (e.g., gNB 120) and the 5G Core (e.g., UPF 260) ensure quality of service (e.g., reliability and target delay) by mapping packets to appropriate QoS flows 306a-c and DRBs 304a-b. Hence there is a 2-step mapping of IP-flows to QoS flows (NAS) and from QoS flows 306a-c to DRBs 304a-b (Access Stratum).

In some examples, the QoS flow is identified by QFI within PDU session 302. This QFI is carried in an encapsulation header over N3. For each UE, 5GC establishes one or more PDU sessions and 5G-RAN establishes at least one DRB together with PDU session. Additional DRBs are configured for QoS flows of that PDU session consecutively. 5G-RAN maps packets which belong to the different PDU sessions to different DRBs. At the NAS level, a QoS flow is characterized by a QoS profile provided by 5GC to 5G-RAN and QoS rule(s) provided by 5GC to the UE. A QoS flow may either be GBR or Non-GBR depending on its profile. The QoS profile is used by gNB to determine the treatment on the radio interface. QoS rules dictate the mapping between uplink User Plane traffic and QoS flows to the UE.

At the AS level, the DRB defines the packet treatment on the radio interface (Uu). A DRB serves packets with the same packet forwarding treatment. The QoS flow to DRB mapping by gNB is based on QFI and the associated QoS profiles (i.e., QoS parameters and QoS characteristics). Separate DRBs may be established for QoS flows requiring different packet forwarding treatment, or several QoS flows belonging to the same PDU session can be multiplexed in the same DRB.

A 5G Network can provide the UE, one or more QoS flow descriptions associated with a PDU session during the PDU session establishment or at the PDU session modification. Each QoS flow includes the following details: a 5G QoS Identifier (“5QI”); and an Allocation and Retention Priority (“ARP”). In case of a GBR QoS flow, the QoS flow can also include a Guaranteed Flow Bit Rate (“GFBR”) for both uplink and downlink; a Maximum Flow Bit Rate (“MFBR”) for both uplink and downlink; a Maximum Packet Loss Rate for both uplink and downlink; a Delay Critical Resource Type; and a Notification Control. In case of Non-GBR QoS flow, the QoS flow can include a Reflective QoS Attribute (“RQA”); a Session-aggregate maximum bit rate (“AMBR”); and a UE-AMBR.

5G QoS characteristics describe the packet forwarding treatment that a QoS flow receives edge-to-edge between the UE and the UPF in terms of the following performance characteristics: Resource Type (GBR, Delay critical GBR or Non-GBR); Priority Level; Packet Delay Budget; Packet Error Rate; Averaging window (for GBR and Delay-critical GBR resource type only); and Maximum Data Burst Volume (for Delay-critical GBR resource type only).

The 5G QoS characteristics should be understood as guidelines for setting node specific parameters for each QoS flow e.g., for 3GPP radio access link layer protocol configurations. Standardized or pre-configured 5G QoS characteristics are indicated through the 5QI value, and are not signaled on any interface, unless certain 5G QoS characteristics are modified.

In this example of a 5GC, there is only a single user plane function (“UPF”) for transport of data between the gNB and the core. DRBs on air interface can have one-to-many relationship with the general packet radio service (“GPRS”) tunnelling protocol (“GTP-U”) tunnel on N3 interface at UPF. Each QoS flow is mapped to a single GTP-U tunnel at N3 interface. gNB may map individual QoS flows to one more DRBs. A PDU session may contain multiple QoS flows and several DRBs but only a single N3 GTP-U tunnel. A DRB may transport one or more QoS flows. The QFI that identifies the flow is carried in an extension header on N3 in the GTP-U protocol, using DL and UL PDU session information frames. The DL and UL PDU session information frame includes a QFI field for each packet. The DL PDU session information frame includes the Reflective QoS Indicator (“RQI”) field to indicate whether the user plane reflective QoS is to be activated or not. This is only applicable if reflective QoS is activated.

There currently exist certain challenges. There are no solutions that consider the patients' medical conditions and other patient attributes to define, set and change (modify) the QoS levels in 5GS.

Certain aspects of the disclosure and their embodiments may provide solutions to these or other challenges.

Various embodiments described herein allow a patient's overall healthcare traffic to be prioritized, which may come from different sources, or specific sub streams (such as video), based on the medical state of that patient. In some examples, the traffic associated with a patient is prioritized based on measurements of the patient's vital signs (measurements of the patient's most basic functions). The four main vital signs routinely monitored by medical professionals and health care providers include the following: Body temperature; Heart rate (Pulse); Respiratory rate; and Blood pressure. Other vital signs can include, for example, Oxygen saturation (as measured by pulse oximetry) and Blood Glucose level.

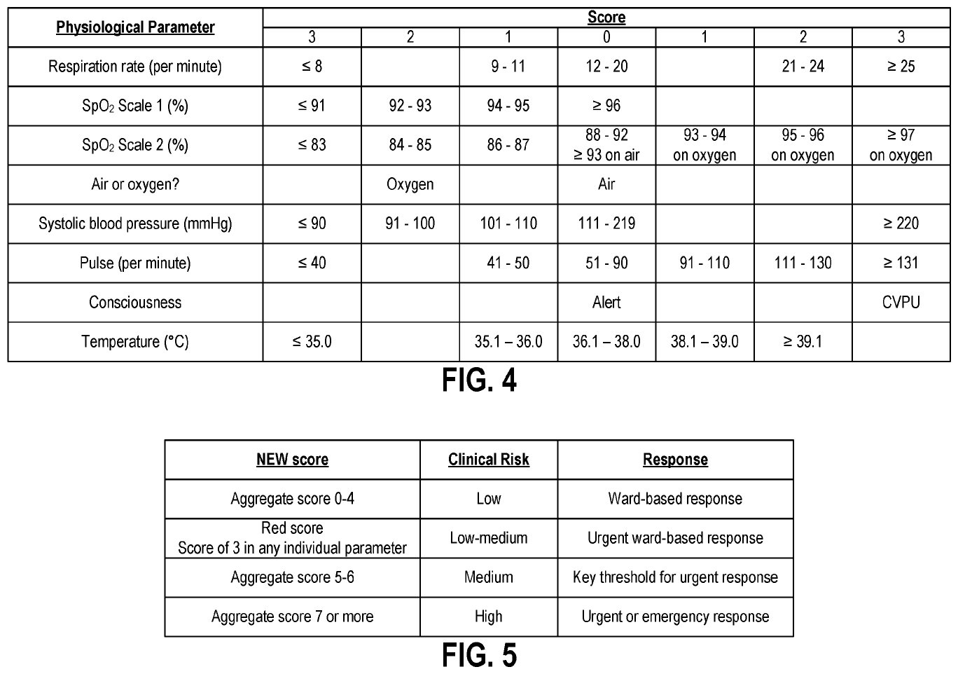

In some embodiments, these vital signs are used to determine an aggregate numerical value to represent a patient's condition. For example, an aggregate numerical value associated with a patient's medical state can be determined using the National Early Warning Score (“NEWS”) system by the United Kingdom's National Health Service (“NHS”), first produced in 2012 and updated (as NEWS2) in December 2017, which advocates a system to standardize the assessment and response to acute illness. The NEWS is based on a simple aggregate scoring system in which a score is allocated to physiological measurements, already recorded in routine practice, when patients present to, or are being monitored in a hospital. Six physiological parameters form the basis of the scoring system: respiration rate; oxygen saturation; systolic blood pressure; pulse rate; level of consciousness or new confusion; and temperature. Each of these parameters can be measured and given a score, for example, according to the chart in FIG. 4. From the scoring system the overall clinical risk and response can be determined, as illustrated in FIG. 5. Systems like NEWS2 or other process and procedures can also be used to determine the patient's overall medical state.

For the USA, a wide range of terms may be used to describe a patient's condition. The American Hospital Association advises physicians to use the following one-word conditions in describing a patient's condition to those inquiring: Undetermined; Good; Fair; Serious; Critical; and Dead. Undetermined is used to refer to a patient awaiting physician and/or assessment. Good is used to refer to a patient whose vital signs are stable and within normal limits: patient is conscious and comfortable; and indicators are excellent. Fair is used to refer to a patient whose vital signs are stable and within normal limits; patient is conscious, but may be uncomfortable; indicators are favorable. Serious is used to refer to a patient whose vital signs may be unstable and not within normal limits; patient is seriously ill; and indicators are questionable. Critical is used to refer to a patient whose vital signs are unstable and not within normal limits; patient may be unconscious; and indicators are unfavorable. Dead is used to refer to a patient whose vital signs have ceased; and patient has died.

In addition to a patient's medical states there may be other relevant patient attributes that are inputs to how the healthcare data should be prioritized. In some examples, a patient's medical history, condition (e.g., age, pre-existing conditions), or type of illness can be used as inputs as they can indicate whether the patient has a significant risk of deteriorating. In additional or alternative examples, economic considerations (e.g., the patient's insurance) can be used as input to lead to differentiated treatment. In additional or alternative examples, a patient's status in society (e.g., leader of government, industry, VIP) can be used to determine how to prioritize data associated with a patient.

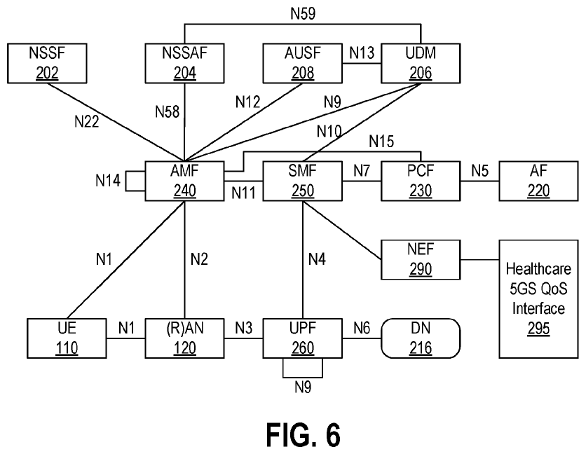

In some embodiments, the overall data traffic priority from the above is used with a system interfacing the 5G core, as illustrated in FIG. 6. The 5GS illustrated in FIG. 6 includes a Network Slice Selection Function (“NSSF”) 202, Network Slice Authentication and Authorization Function (“NSSAF”) 204, Authentication Server Function (“AUSF”) 208, Unified Data Management (“UDM”) 206, Access and mobility Management Function (“AMF”) 240, Session Management Function (“SMF”) 250, Policy Control Function (“PCF”) 230, Application Function (“AF”) 220, Network Exposure Function (“NEF”) 290, Healthcare 5GS QoS Interface 295, UE 110, RAN 120 (also referred to here as an AN), User Plane Function (“UPF”) 260, and Data Network (“DN”) 216.

The Healthcare 5GS QoS Interface 295 can include (or be communicatively coupled to) a manual or automated system to provide inputs to request traffic priority level using an application programming interface (“API”) exposed from a 5G system via a Healthcare 5GS QOS Interface function. The manual input can include a user interface for healthcare staff (e.g., ambulance staff, physicians, and administrative staff). The automated system can include an application server with the application software for aggregation of medical equipment measuring vital signs, producing NEWS2 scores, AI assisted predictions, and/or updating the QoS profiles based on new medical state data. This function can make API calls to the 5GC Network exposure function (“NEF”) 290 which in turn makes API calls within the 5GC trust domain including to the SMF 250, which can modify traffic priority via PDU session modification procedure to the UPF 260, AN 120, and UE 110 functions, which controls the data plane QoS flows (for example the QoS flow max and guaranteed bit rates, priority levels).

Certain embodiments may reduce the risk of a medical patient's vital medical data being lost by the wireless network, and thereby going unnoticed by medical staff. Reducing this risk can improve patient care.

An example implementation of some embodiments is described below.

First, a Healthcare user equipment (“HUE”) is activated. Patient A (“P-A”) may have recently experienced an acute medical condition. During recovery, there is a risk of sudden emergencies, so a wearable patch (e.g., the HUE is this example) is placed on P-A, which is continuously measuring vital signs and reporting them using 5G connectivity. In this way, medical staff can quickly be informed of emergencies, and using artificial intelligence (“AI”) also get early notifications of emerging acute conditions. P-A may feel well and move freely within and in the vicinity of the hospital, even doing occasional trips home. Thus, the HUE connectivity can make use of both the indoor hospital facility wireless 5G RAN network as well as the outdoor macro 5G RAN network.

Second, a QoS flow can be defined. Using the Healthcare 5GS QoS Interface (“H5GQI”) (e.g., H5GQI 295 of FIG. 6), the healthcare staff can manually insert P-A's Patient ID for the HUE, and thereby defined a new QFI. In some examples, the Patient ID is mapped to the patch device (HUE), which has an IP address, which together with the IP address of the server handling this data defines the IP flows of this traffic. In additional or alternative examples, the QoS flow is controlled by the SMF and may be preconfigured, or established via the PDU Establishment procedure or the PDU Session Modification procedure. This QFI is characterized by QoS profile provided by 5GC SMF to 5G-RAN (e.g., used by the gNB) and QoS rule(s) provided by 5GC SMF to the UE.

Predefined by the 5GC AMF in the gNB (or provided by the AMF over the N2 interface), the QoS flow is using a profile called Medical Vital Signs (5GI number NN). This QoS profile has: an Allocation and Retention Priority (“ARP”) of initially 5, which is based on P-A's age, gender, prior history, and current condition; Guaranteed Flow Bit Rate (“GFBR”) with an uplink of 0.5 Mbps and downlink of 0.1 Mbps; a Maximum Flow Bit Rate (“MFBR”) with uplink and downlink of 10 Mbps; a Maximum Packet Loss Rate with an uplink and downlink of 10⁻⁵ packets within 100 ms; a Delay Critical Resource Type of Delay critical type with a max delay defined of 20 ms; and a Notification Control.

The QoS rule called Medical Vital Signs is used by the HUE. This QoS rule is mirroring the QoS profile above, and is provided by the SMF to the HUE via the AMF over the N1 reference point.

In addition to the QoS handling defined above, the vital signs data from P-A is mapped to a Network slice (identified by a Network Slice Selection Assistance Information (“NSSAI”)) being mapped to the PDU session of the above QoS flow. The Network slice may for example be “Healthcare Provider X Patient Observability data”, carrying many patient QoS flows. This Network slice then connects to the data network with the data servers containing the application software using P-A's medical vital signs data.

Healthcare 5GS QoS Interface traffic QoS flow can be part of the Medical Vital Signs Network slice using the Healthcare 5GS QoS Interface.

Third, vital signs thresholds and automatic network priority adjustments are made. Using FIGS. 4-5, PA's HUE reports (via the Healthcare 5GS QoS Interface 295 in FIG. 6 and/or an Automated Medical System communicatively coupled to the Healthcare 5GS QOS Interface 295) that the vital signs are degrading resulting in that one or more thresholds are passed. The Automated Medical System then determines that the QoS profiles and rules need to be improved with a better value (e.g., 3) of the ARP and potentially other parameters as well. Using the H5GQI interface to the NEF, the SMF is using a PDU Session Modification procedure to change the QoS parameters of P-A's QoS flow.

The intended result can be that PA's data is prioritized over other data including other, less critical patients' data, in case of network resource contention.

ARP is described further below.

The QoS parameter ARP can include information about the priority level, the pre-emption capability and the pre-emption vulnerability. The ARP priority level defines the relative importance of a resource request to allow in deciding whether a new QoS flow may be accepted or needs to be rejected in the case of resource limitations (typically used for admission control of GBR traffic). It may also be used to decide which existing QoS flow to pre-empt during resource limitations.

In some embodiments, the range of the ARP priority level is 1 to 15 with 1 as the highest level of priority.

In additional or alternative embodiments, the ARP priority levels 1-8 should only be assigned to resources for services that are authorized to receive prioritized treatment within an operator domain (e.g., that are authorized by the serving network).

In additional or alternative embodiments, the ARP priority levels 9-15 may be assigned to resources that are authorized by the home network and thus applicable when a UE is roaming.

In additional or alternative embodiments, the ARP pre-emption capability defines whether a service data flow may get resources that were already assigned to another service data flow with a lower level of priority (i.e., a higher ARP priority level value).

In additional or alternative embodiments, the ARP pre-emption capability and the ARP pre-emption vulnerability shall be either set to ‘enabled’ or ‘disabled.’

In additional or alternative embodiments, the ARP pre-emption vulnerability defines whether a service data flow may lose the resources assigned to it in order to admit a service data flow with higher ARP priority level.

In additional or alternative embodiments, the ARP pre-emption vulnerability of the QoS flow which the default QoS rule is associated with should be set appropriately to minimize the risk of unnecessary release of this QoS flow.

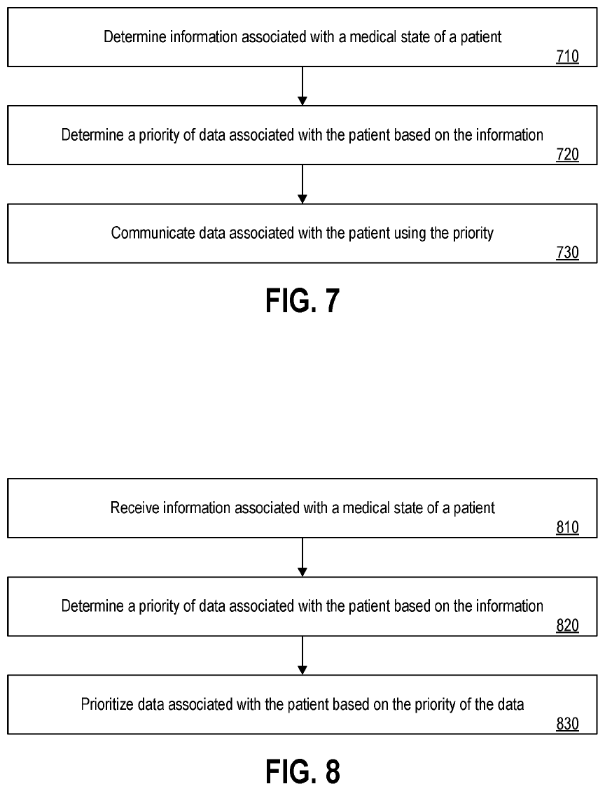

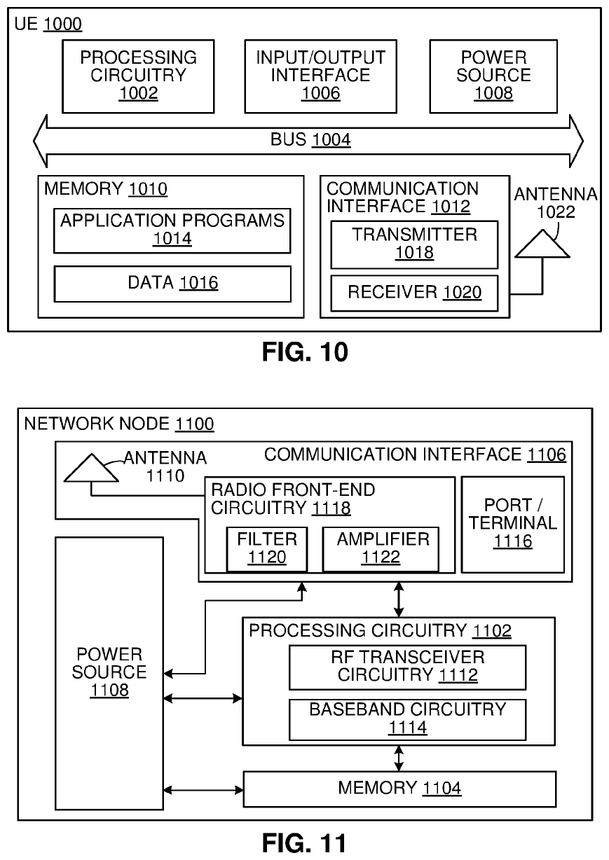

In the description that follows, while the communication device may be any of UE 110, 912A-D, 1000, hardware 1304, or virtual machine 1308A, 1308B, the communication device 1000 shall be used to describe the functionality of the operations of the communication device. Operations of the communication device 1000 (implemented using the structure of FIG. 10) will now be discussed with reference to the flow chart of FIG. 7 according to some embodiments of inventive concepts. For example, modules may be stored in memory 1010 of FIG. 10, and these modules may provide instructions so that when the instructions of a module are executed by respective communication device processing circuitry 1002, processing circuitry 1002 performs respective operations of the flow chart.

FIG. 7 illustrates an example of operations performed by a communication device in a communications network that includes a network node. In some embodiments, the network node includes at least one of: a radio access network, RAN, node; and a core network, CN, node. In additional or alternative embodiments, the communication device includes at least one of: a healthcare user equipment, HUE; a wearable device; and a medical sensor.

At block 710, processing circuitry 1002 determines information associated with a medical state of a patient. In some embodiments, the information includes at least one of: a respiration rate of the patient; an oxygen saturation of the patient; a systolic blood pressure of the patient; a pulse rate of the patient; a level of consciousness of the patient; a temperature of the patient; an aggregate numerical value indicating a medical state of the patient; and a term indicating a severity of the medical state of the patient.

At block 720, processing circuitry 1002 determines a priority of data associated with the patient based on the information. In some embodiments, determining the priority of the data associated with the patient based on the information includes transmitting the information to the network node; and responsive to transmitting the information, receiving an indication of a priority of the data. In additional or alternative embodiments, receiving the indication of the priority of the data includes receiving a Quality of Service Flow Identifier, QFI, associated with a Quality of Service, QoS, profile associated with the data. In some examples, the QoS profile includes an indication of at least one of: an allocation and retention priority, ARP; a guaranteed flow bit rate, GFBR: a maximum flow bit rate, MFBR; a maximum packet loss rate; a delay critical resource type; and a notification control.

In some embodiments, determining the priority of the data associated with the patient based on the information includes determining at least one of: whether the medical state of the patient exceeds a first threshold level; whether the medical state of the patient has fallen below a second threshold level; whether the medical state of the patient exceeds a threshold range; and whether a rate of change in the medical state of the patient exceeds a threshold rate. In some examples, determining that the medical state of the patient exceeds the first threshold includes determining that a patient's temperature exceeds a healthy temperature. In additional or alternative examples, determining that the medical state of the patient has fallen below the second threshold level includes determining that the patient's oxygen level has fallen below a healthy oxygen level. In additional or alternative examples, determining that the medical state of the patient exceeds the threshold range includes determining that the patient's heartrate is above or below a healthy heart rate range. In additional or alternative examples, determining that the rate of change in the medical state of the patient exceeds a threshold rate includes determining that a patient's NEW score has increased at such a high rate (above the third threshold level) that the patient is considered to be quickly deteriorating and therefore the patient's data is given a higher priority.

At block 730, processing circuitry 1002 communicates, via communication interface 1012, data associated with the patient using the priority. In some embodiments, the patient includes a first patient of a plurality of patients associated with the communication device. Communicating the data associated with the patient includes prioritizing the data associated with the first patient over data associated with a second patient of the plurality of patients.

In some embodiments, communicating the data associated with the patient includes transmitting a message including the data and the QFI in the header.

Various operations of FIG. 7 may be optional with respect to some embodiments.

In the description that follows, while the network node may be any of RAN 120, UPF 260, AMF 240. SMF 250, NEF 290, H5GQI 295, CN Node 908, Network Node 910A-B, 1100, hardware 1304, or virtual machine 1308A, 1308B, the network node 1100 shall be used to describe the functionality of the operations of the network node. Operations of the network node 1100 (implemented using the structure of FIG. 11) will now be discussed with reference to the flow chart of FIG. 8 according to some embodiments of inventive concepts. For example, modules may be stored in memory 1104 of FIG. 11, and these modules may provide instructions so that when the instructions of a module are executed by respective network node processing circuitry 1102, processing circuitry 1102 performs respective operations of the flow chart.

FIG. 8 illustrates an example of operations performed by a network node in a communications network that includes a communication device. In some embodiments, the network node includes at least one of: a radio access network, RAN, node; and a core network, CN, node. The communication device includes at least one of: a healthcare user equipment, HUE; a wearable device; and a medical sensor.

At block 810, processing circuitry 1102 receives, via communication interface 1106, information associated with a medical state of a patient. In some embodiments, receiving the information includes receiving a request from the communication device to determine the priority of the data associated with the patient. In additional or alternative embodiments, receiving the information includes receiving at least one of: a respiration rate of the patient; an oxygen saturation of the patient; a systolic blood pressure of the patient; a pulse rate of the patient; a level of consciousness of the patient; a temperature of the patient; an aggregate numerical value indicating a medical state of the patient; and a term indicating a severity of the medical state of the patient.

At block 820, processing circuitry 1102 determines a priority of data associated with the patient based on the information. In some embodiments, determining the priority of the data associated with the patient includes determining the priority of the data based on the medical state exceeding a threshold.

In some embodiments, the information includes current information indicating a current medical state of the patient. Determining the priority of the data associated with the patient includes determining the priority of the data based on a change between the current information and previous information indicating a previous medical state of the patient. In additional or alternative embodiments, determining the priority of the data associated with patient further includes determining the priority of the data associated with the patient based on an amount of time between receiving the current information and receiving the previous information. In some examples, a patient may have a NEW score of 2 at a first time (e.g., right after a surgery) and then the patient may have a NEW score of 6 at a second time (e.g., 1 hour after the surgery). Although a new score of 6 may only be considered a medium risk (such that the patient's data is given a medium priority), the fact that the patient's medical state has dropped (gone up in NEW score) so quickly may be an indicator that the patient's medical state is rapidly deteriorating. Accordingly, by observing the change in the patient's medical state, the processing circuitry 1102 may determine to give greater priority to the data associated with the patient.

In some embodiments, determining the priority of the data includes creating or modifying a Quality of Service, QoS, profile associated with the data. In some examples, the QoS profile includes an indication of at least one of: an allocation and retention priority, ARP; a guaranteed flow bit rate, GFBR; a maximum flow bit rate, MFBR: a maximum packet loss rate; a delay critical resource type; and a notification control.

At block 830, processing circuitry 1102 prioritizes data associated with the patient based on the priority of the data. In some embodiments, prioritizing the data associated with the patient includes transmitting an indication of a QoS Flow Identifier, QFI, associated with the QoS profile to the communication device with instructions to include the QFI in a header of messages that include the data.

In some embodiments, prioritizing the data associated with the patient includes: receiving a plurality of data including data associated with the patient; and communicating the data associated with the patient before other data of the plurality of data based on the priority of the data associated with the patient.

In some embodiments, prioritizing the data associated with the patient includes allocating more network resources for the data associated with the patient than for other data being communicated on the communications network.

Various operations of FIG. 8 may be optional with respect to some embodiments.

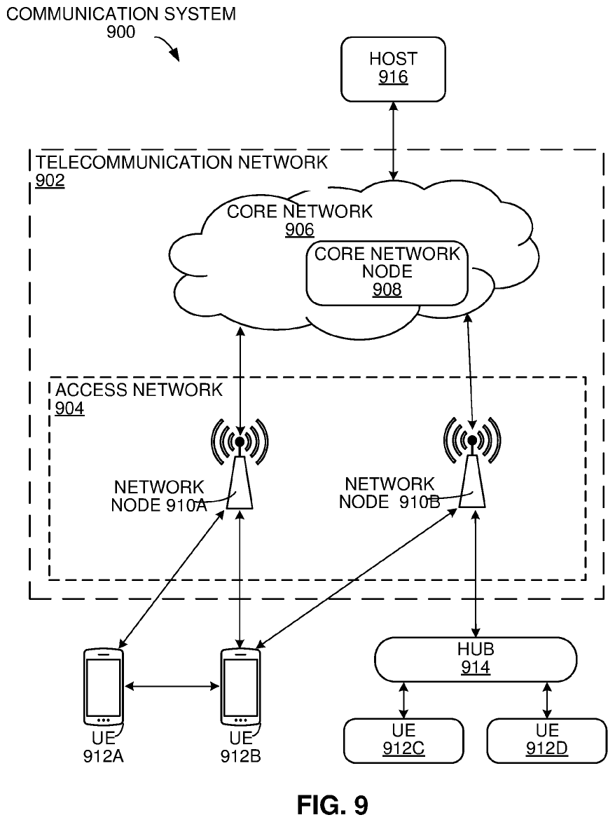

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME). Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS. WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi. Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

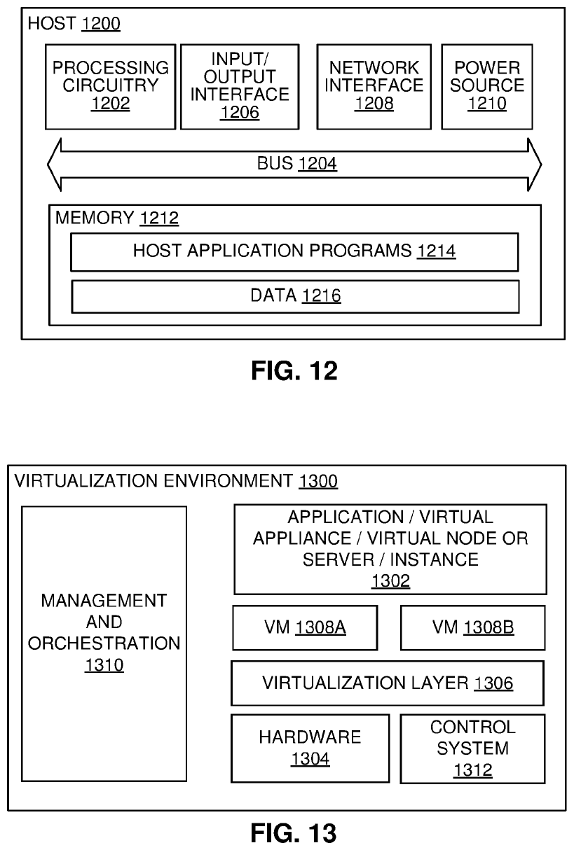

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10-11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

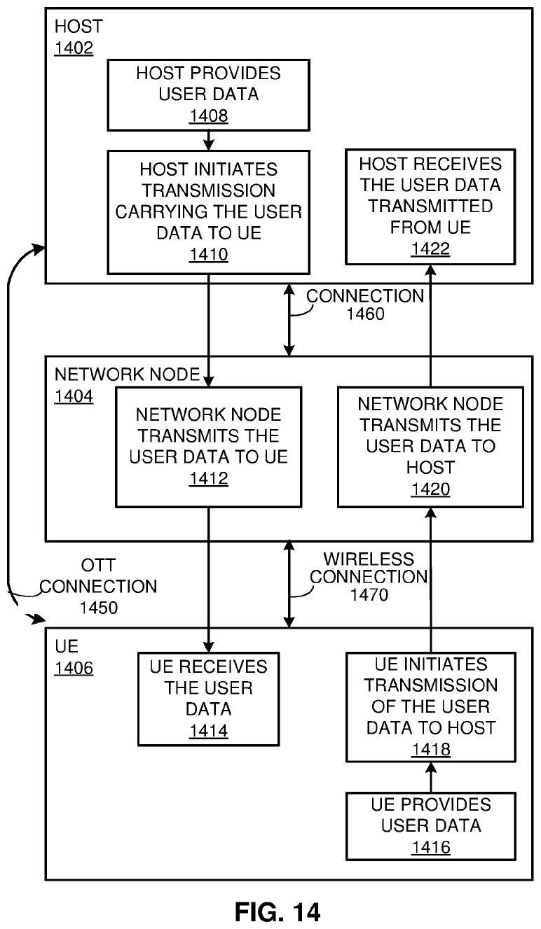

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may reduce the risk of a medical patient's vital medical data being lost by the wireless network, and thereby going unnoticed by medical staff. Reducing this risk can improve patient care.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device in a communications network that includes a network node, the method comprising:
determining information associated with a medical state of a patient associated with the communication device;
determining a priority of data associated with the patient based on the information; and
communicating data associated with the patient using the priority.

2. The method of claim 1, wherein determining the priority of the data associated with the patient based on the information comprises:
transmitting the information to the network node; and
responsive to transmitting the information, receiving an indication of a priority of the data.

3. The method of claim 2, wherein receiving the indication of the priority of the data comprises receiving a Quality of Service Flow Identifier, QFI, associated with a Quality of Service, QoS, profile associated with the data, and
wherein communicating the data associated with the patient comprises transmitting a message comprising the data and the QFI in the header.

4. The method of claim 3, wherein the QoS profile comprises an indication of at least one of:
an allocation and retention priority, ARP;
a guaranteed flow bit rate, GFBR;
a maximum flow bit rate, MFBR;
a maximum packet loss rate;
a delay critical resource type; and
a notification control.

5. The method of claim 1, wherein determining the priority of the data associated with the patient based on the information comprises determining at least one of:
whether the medical state of the patient exceeds a first threshold level;
whether the medical state of the patient is below a second threshold level;
whether the medical state of the patient is outside of a threshold range; and
whether a rate of change in the medical state of the patient exceeds a threshold rate.

6. The method of claim 1, wherein the patient comprises a first patient of a plurality of patients associated with the communication device,
wherein communicating the data associated with the patient comprises:
prioritizing the data associated with the first patient over data associated with a second patient of the plurality of patients.

7. The method of claim 1, wherein the information comprises at least one of:
a respiration rate of the patient;
an oxygen saturation of the patient;
a systolic blood pressure of the patient;
a pulse rate of the patient;
a level of consciousness of the patient;
a temperature of the patient;
an aggregate numerical value indicating a medical state of the patient; and
a term indicating a severity of the medical state of the patient.

8. The method of claim 1, wherein the network node comprises at least one of:
a radio access network, RAN, node; and
a core network, CN, node, and
wherein the communication device comprises at least one of:
a healthcare user equipment, HUE;
a wearable device; and
a medical sensor.

9. A method of operating a network node in a communications network that includes a communication device, the method comprising:
receiving information associated with a medical state of a patient, the patient being associated with the communication device;
determining a priority of data associated with the patient based on the information; and
prioritizing data associated with the patient based on the priority of the data.

10. The method of claim 9, wherein receiving the information comprises receiving a request from the communication device to determine the priority of the data associated with the patient.

11. The method of claim 9, wherein receiving the information comprises receiving at least one of:
a respiration rate of the patient;
an oxygen saturation of the patient;
a systolic blood pressure of the patient;
a pulse rate of the patient;
a level of consciousness of the patient;
a temperature of the patient;
an aggregate numerical value indicating a medical state of the patient; and
a term indicating a severity of the medical state of the patient.

12. The method of claim 9, wherein determining the priority of the data associated with the patient comprises determining the priority of the data based on the medical state exceeding a threshold.

13. The method of claim 9, wherein the information comprises current information indicating a current medical state of the patient,
wherein determining the priority of the data associated with the patient comprises determining the priority of the data based on a change between the current information and previous information indicating a previous medical state of the patient.

14. The method of claim 13, wherein determining the priority of the data associated with patient further comprises determining the priority of the data associated with the patient based on an amount of time between receiving the current information and receiving the previous information.

15. The method of claim 9, wherein determining the priority of the data comprises creating or modifying a Quality of Service, QoS, profile associated with the data.

16. The method of claim 15, wherein the QoS profile comprises an indication of at least one of:
an allocation and retention priority, ARP;
a guaranteed flow bit rate, GFBR;
a maximum flow bit rate, MFBR;
a maximum packet loss rate;
a delay critical resource type; and
a notification control.

17. The method of claim 15, wherein prioritizing the data associated with the patient comprises:
transmitting an indication of a QoS Flow Identifier, QFI, associated with the QoS profile to the communication device with instructions to include the QFI in a header of messages that include the data.

18. The method of claim 9, wherein prioritizing the data associated with the patient comprises:
receiving a plurality of data including data associated with the patient; and
communicating the data associated with the patient before other data of the plurality of data based on the priority of the data associated with the patient.

19. The method of claim 9, wherein prioritizing the data associated with the patient comprises:
allocating more network resources for the data associated with the patient than for other data being communicated on the communications network.

20. (canceled)

21. A communication device, the communication device comprising:
processing circuitry; and
memory coupled to the processing circuitry and having instructions stored therein that are executable by the processing circuitry to cause the communication device to perform operations comprising:
determining information associated with a medical state of a patient associated with the communication device;
determining a priority of data associated with the patient based on the information; and
communicating data associated with the patient using the priority.

22.-24. (canceled)
